(19) United States
(12) Patent Application Publication
(10) Pub. No.: US 2023/0106891 A1
(43) Pub. Date: Apr. 6, 2023

(54) USING CHARGING PATH STEP-DOWN POWER CONVERTER TO PROVIDE BOOSTED SUPPLY FOR DEVICE COMPONENTS

(71) Applicant: Cirrus Logic International Semiconductor Ltd., Edinburgh (GB)

(72) Inventors: Christian LARSEN, Austin, TX (US); Eric J. KING, Austin, TX (US)

(73) Assignee: Cirrus Logic International Semiconductor Ltd., Edinburgh (GB)

(21) Appl. No.: 17/944,498

(22) Filed: Sep. 14, 2022

Related U.S. Application Data
(60) Provisional application No. 63/251,971, filed on Oct. 4, 2021.

(51) Int. Cl. H02J 7/00; H02M 3/04

(52) U.S. Cl. CPC H02J 7/0068; H02M 3/04; H02J 7/0063; H02J 2207/20

(57) ABSTRACT

In accordance with embodiments of the present disclosure, an electronic device may include a battery and a power converter coupled to the battery and configured to be coupled between the battery and a power source. The power converter may be configured to, in a first mode, couple to the power source having a source voltage and charge the battery with a charging voltage significantly smaller than the source voltage. The power converter may be further configured to, in a second mode, couple between at least one downstream component of the electronic device and the battery to provide electrical energy to the at least one downstream component from the battery at a boost voltage significantly larger than a battery voltage generated by the battery.

### RELATED APPLICATION

The present disclosure claims priority to U.S. Provisional Patent Application Ser. No. 63/251,971, filed Oct. 4, 2021, which is incorporated by reference herein in its entirety.

### FIELD OF DISCLOSURE

The present disclosure relates in general to circuits for electronic devices, including without limitation personal audio devices such as wireless telephones and media players, and more specifically, to a power interface including a charging path with a step-down power converter that doubles as a step-up power converter to provide a boosted power supply.

### BACKGROUND

Portable electronic devices, including wireless telephones, such as mobile/cellular telephones, tablets, cordless telephones, mp3 players, smart watches, health monitors, and other consumer devices, are in widespread use. Such a portable electronic device may include a battery (e.g., a lithium-ion battery) for powering components of the portable electronic device. Typically, such batteries used in portable electronic devices are rechargeable, such that when charging, the battery converts electrical energy into chemical energy which may later be converted back into electrical energy for powering components of the portable electronic device.

A battery charging system often includes one or more power converters that may receive a power supply voltage (e.g., from an alternating current-to-direct current adapter plugged into a wall outlet) and convert such power supply voltage to a suitable voltage for charging a battery. For example, some charging systems employ a step-down converter (e.g., a buck converter or step-down switched capacitor power converter) for receiving the power supply voltage and converting the power supply voltage to a charging voltage lower than the power supply voltage.

For example, FIG. 1 depicts an example block diagram of selected components of a system 100A for charging a battery 102 of an electronic device 101A, as is known in the art. As shown in FIG. 1, system 100A may include a USB wall adapter 104 configured to supply electrical energy to device 101A in the form of bus voltage V_{BUS} (e.g., a relatively constant direct current (DC) voltage). Further, electronic device 101A may include a wireless charging subsystem 105 which may include a wireless receiver module configured to wirelessly receive energy from a wireless transmission module (e.g., via inductive coupling) and generate a wireless subsystem voltage V_{WPC} (e.g., a relatively constant DC voltage). A master charger 108 may receive either or both of bus voltage V_{BUS} and wireless subsystem voltage V_{WPC} and convert such voltage to a system voltage V_{SYS} which may power downstream components and/or, when switch 126 of master charger is closed, charge battery 102.

As also shown in FIG. 1, electronic device 101A may include a sidecar converter 110. Sidecar converter 110 may be a step-down converter which is often implemented using a 2:1 switch-capacitor charge pump power converter which converts an input voltage (e.g., V_{BUS} or V_{WPC}) to a lower voltage at its output, which may be coupled to battery 102. Sidecar converter 110 may be configured to regulate power when electronic device 101A is being powered by battery 102 and being charged by wireless charging subsystem 105/USB wall adapter 104. Fast charging, which may be enabled if USB wall adapter 104 is a USB Power Delivery/Programmable Power Supply (PD/PPS) or similarly-enabled component, may require a bus voltage V_{BUS} that is a generally high voltage which is stepped down by sidecar converter 110 in order to charge the battery.

When electronic device 101A is being charged by wireless charging subsystem 105 or USB wall adapter 104, master charger 108 may be able to adequately provide system power V_{SYS} to downstream components (e.g., boosted amplifiers 118 having their own DC/DC converters 122 and amplifiers 124 for powering output loads 120, such as speakers, haptic transducers, or other transducers). On the other hand, when electronic device 101A is not being charged and instead components of electronic device 101A are being powered from battery 102, boost operations of boosted amplifiers 118 may be employed to provide adequate energy and voltage to drive output loads 120.

However, the presence of sidecar converter 110 and multiple boosted amplifiers 118 requires the use of many components, which in turn requires significant cost and circuit area.

FIG. 2 depicts an example block diagram of selected components of a system 100B for charging battery 102 of an electronic device 101B, as is known in the art, which may improve over system 100A depicted in FIG. 1. System 100B may be similar in many respects to system 100A, including being similar in functionality, except that instead of employing a plurality of boosted amplifiers 118 to drive a plurality of loads 120, system 100B may employ individual high-voltage amplifiers 130 supplied from a separate boost converter 128. System 100B, as compared to system 100A, may have the advantage of providing higher-power output to output loads 120 while minimizing thermal limitations by separating thermal power losses between boost converter 128 and high-voltage amplifiers 130. However, even with such advantage, system 100B too requires many components, also resulting in significant cost and circuit area.

### SUMMARY

In accordance with the teachings of the present disclosure, one or more disadvantages and problems associated with existing approaches to battery charging may be reduced or eliminated.

In accordance with embodiments of the present disclosure, an electronic device may include a battery and a power converter coupled to the battery and configured to be coupled between the battery and a power source. The power converter may be configured to, in a first mode, couple to the power source having a source voltage and charge the battery with a charging voltage significantly smaller than the source voltage. The power converter may be further configured to, in a second mode, couple between at least one downstream component of the electronic device and the battery to provide electrical energy to the at least one downstream component from the battery at a boost voltage significantly larger than a battery voltage generated by the battery.

In accordance with these and other embodiments of the present disclosure, a method may include, in a system having a battery and a power converter coupled to the battery and configured to be coupled between the battery and a power source, and in a first mode, coupling the power converter to the power source having a source voltage and charging the battery with a charging voltage significantly smaller than the source voltage. The method may also include, in a second mode, coupling the power converter between at least one downstream component of the electronic device and the battery to provide electrical energy to the at least one downstream component from the battery at a boost voltage significantly larger than a battery voltage generated by the battery.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example block diagram of selected components of a system for charging a battery of an electronic device, as is known in the art;

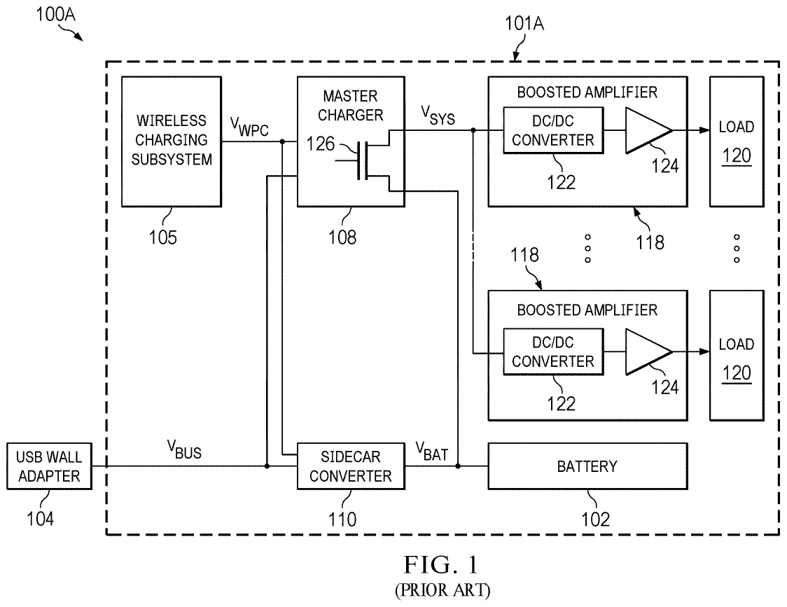

FIG. 2 illustrates an example block diagram of selected components of another system for charging a battery of an electronic device, as is known in the art;

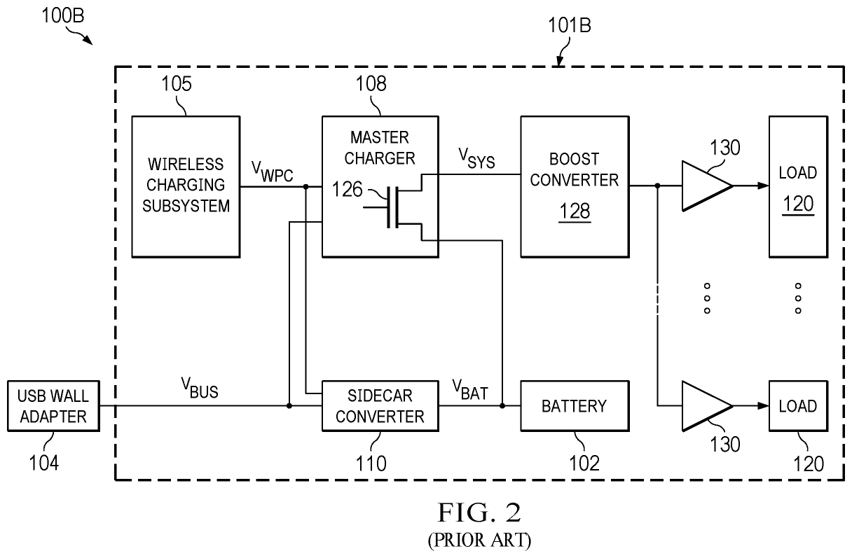

FIG. 3 illustrates an example system for charging a battery of an electronic device, in accordance with embodiments of the present disclosure; and

FIG. 4 illustrates another example system for charging a battery of an electronic device, in accordance with embodiments of the present disclosure.

### DETAILED DESCRIPTION

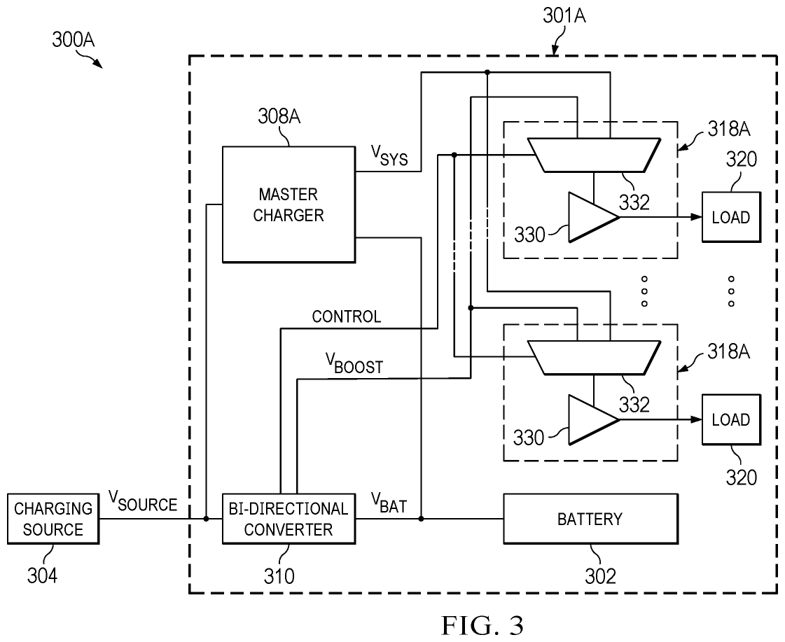

FIG. 3 illustrates an example system 300A for charging a battery 302 of an electronic device 301A, in accordance with embodiments of the present disclosure. As shown in FIG. 3, system 300A may include electronic device 301A and a charging source 304.

Electronic device 301A may be any suitable electronic device, including without limitation a mobile phone, smart phone, tablet, laptop/notebook computer, media player, handheld, smart watch, gaming controller, etc. As shown in FIG. 3, device 300 may include a battery 302, a master charger 308A, a bi-directional converter 310, one or more multiplexed-supply amplifiers 318A, and one or more loads 320 each driven by a respective multiplexed-supply amplifier 318A.

Battery 302 may include any system, device, or apparatus configured to convert chemical energy stored within battery 302 to electrical energy. For example, in some embodiments, battery 302 may be integral to a portable electronic device, and battery 302 may be configured to deliver electrical energy to multiplexed-supply amplifiers 318A and other downstream components of electronic device 301A. Further, battery 302 may also be configured to recharge, in which it may convert electrical energy received by battery 302 from master charger 308A and/or bidirectional converter 310 into chemical energy to be stored for later conversion back into electrical energy. As an example, in some embodiments, battery 302 may comprise a lithium-ion battery.

Charging source 304 may include any suitable adapter configured to supply electrical energy to device 301A in the form of source voltage V_{SUPPLY} (e.g., a relatively constant direct current or DC voltage). In some embodiments, charging source 304 may include a USB wall adapter, including without limitation a PD/PPS-enabled wall adapter. In these and other embodiments, charging source 304 may include a wireless charging source (in which case some or all components of charging source 304 may be integral to electronic device 301A), such as a wireless receiver module.

Master charger 308A may include any system, device, or apparatus configured to, when device 301A is coupled to charging source 304, receive control signals and electrical energy from charging source 304 and control delivery of such energy, in the form of system voltage V_{SYS}, to battery 302, multiplexed-supply amplifiers 318, and/or other components of electronic device 301A. For example, in some embodiments, master charger 308A may include an inductive buck converter comprising an inductor and one or more switches for performing buck-based functionality for master charger 308A. However, any suitable regulator may be used to implement master charger 308A, including without limitation a switched-capacitor regulator, a hybrid regulator, and a multi-level regulator.

Bi-directional converter 310 may include any suitable system, device, or apparatus configured to, when electronic device 301A is coupled to charging source 304, operate in a step-down mode to convert source voltage V_{SOURCE} into a battery voltage V_{BAT} significantly smaller than source voltage V_{SOURCE}, in order to charge battery 302. In some embodiments, such charging of battery 302 through bi-directional converter 310 may occur during fast charging, which may be enabled if charging source 304 is a USB PD/PPS enabled component or similarly-enabled component. In addition, when electronic device 301A is decoupled from charging source 304, bi-directional converter 310 may be configured to operate in a step-up mode to converter battery voltage V_{BAT} into a boost voltage V_{BOOST} significantly larger than battery voltage V_{BAT}.

Bi-directional converter 310 may be implemented using any suitable type of power converter, including without limitation a switched-capacitor power converter, a charge pump power converter, or a switched-inductor power converter (e.g., a buck converter in the step-down mode and a boost converter in the step-up mode). For example, if implemented as a switched-capacitor power converter, battery voltage V_{BAT} may be a factor of N smaller than source voltage V_{SOURCE} in the step-down mode and boost voltage V_{BOOST} may be a factor of N larger than battery voltage V_{BAT} in the step-up mode, where N is a converter ratio of such switched-capacitor power converter. Further, bi-directional converter 310 may include logic (e.g., controlled switches) for coupling to boost voltage V_{BOOST} and decoupling from source voltage V_{SOURCE} when electronic device 301A is not enabled for charging and for coupling to source voltage V_{SOURCE} and decoupling from boost voltage V_{BOOST} when electronic device 301A is enabled for charging.

Accordingly, when electronic device 301A is not enabled for charging (meaning system voltage V_{SYS} is unavailable), and battery voltage V_{BAT} is not sufficient to power multiplexed-supply amplifiers 318 and/or other components, bi-directional converter 310 may boost battery voltage V_{BAT} to a higher boost voltage V_{BOOST} that may be capable of powering multiplexed-supply amplifiers 318 and/or other components. For example, in situations when source voltage V_{SOURCE} is high enough, boost voltage V_{BOOST} may be simply coupled to source voltage V_{SOURCE} via switches. As another example, if source voltage V_{SOURCE} is not high enough, then boost voltage V_{BOOST} may be generated as a step up from either source voltage V_{SOURCE}, battery voltage V_{BAT}, or a combination thereof.

When electronic device 301A is enabled for charging, boost voltage V_{BOOST} may be derived from either source voltage V_{SOURCE} and/or as a multiple of battery voltage V_{BAT}.

A multiplexed-supply amplifier 318 may include any suitable system, device, or apparatus configured to select between system voltage V_{SYS} and boost voltage V_{BOOST} as its supply voltage and amplify an input signal (not explicitly shown) into an amplified output signal for driving a respective load 320. As shown in FIG. 3, a multiplexed-supply amplifier 318 may include a respective multiplexer 332 and amplifier 330.

Multiplexer 332 may comprise any suitable system, device, or apparatus configured to, responsive to a control signal indicative of whether electronic device 301A is being charged from charging source 304, select between system voltage V_{SYS} and boost voltage V_{BOOST} as a supply voltage for amplifier 330. For example, in some embodiments, multiplexer 332 may be implemented as a Y-bridge circuit.

Amplifier 330 may include any system, device, or apparatus configured to amplify the input signal of multiplexed-supply amplifier 318 into an amplified output signal for driving a respective load 320. For example, in some embodiments, amplifier 330 may be implemented as a Class-D amplifier.

In some embodiments, a multiplexer 332 may perform Class-G and/or Class-H functionality to select between system voltage V_{SYS} and boost voltage V_{BOOST} based on a signal level of the inputs to/outputs from its associated amplifier 330. For example, instead of utilizing boost voltage V_{BOOST} when available, a multiplexer 332 may be used to instead tap into system voltage V_{SYS} or a lower supply for better efficiency. Thus, multiplexer 332 may allow for dynamically switching between voltage V_{BOOST} and a lower-voltage supply (e.g., system voltage V_{SYS}) based on the output signal or signal stream for improved efficiency during playback.

A load 320 may include any suitable component that may be driven by a multiplexed-supply amplifier 318, including without limitation a speaker, haptic transducer, and/or other transducer.

Other components of electronic device 301A may include any suitable functional circuits or devices of device 301A, including without limitation power systems (e.g., voltage regulators, power converters, etc.), processors, audio coder/decoders, amplifiers, display devices, audio transducers, etc., all of which may be powered from either boost voltage V_{BOOST} and/or system voltage V_{SYS}.

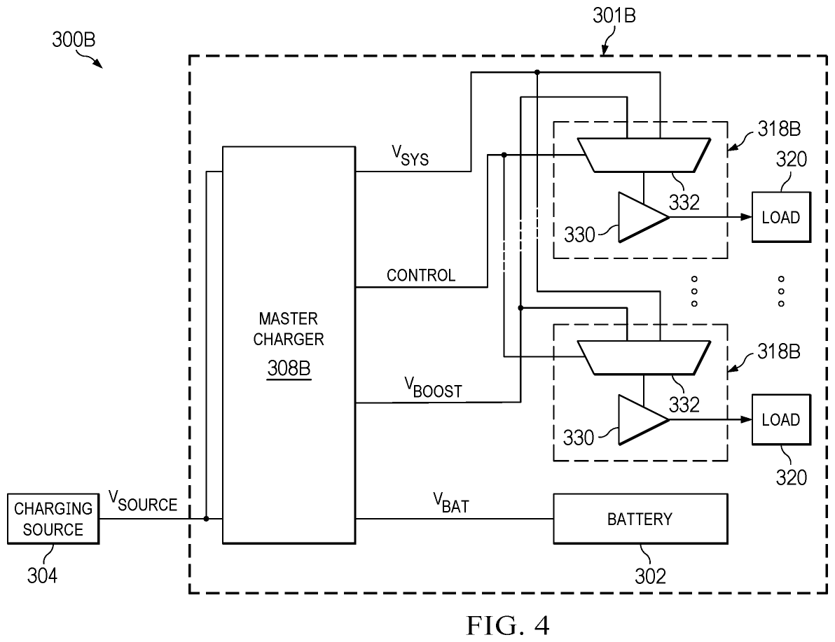

FIG. 4 illustrates an example system 300B for charging a battery 302 of an electronic device 301B, in accordance with embodiments of the present disclosure. As shown in FIG. 4, system 300B may include electronic device 301B and a charging source 304. Electronic device 301B may be similar in many respects to electronic device 301A, except that electronic device 301B may not include bi-directional converter 310. In addition, unlike master charger 308A depicted in FIG. 3, master charger 308B may operate bi-directionally in a manner similar to that of bi-directional converter 310 of FIG. 3.

For example, master charger 308B may include logic (e.g., controlled switches) for charging battery 302 from charging source 304 when electronic device 301B is enabled for charging (e.g., operating in a buck mode to charge battery 302 at a battery voltage V_{BAT} significantly smaller than source voltage V_{SOURCE}) and for boosting (e.g., by essentially operating the buck circuitry for charging in reverse) battery voltage V_{BAT} to a higher boost voltage V_{BOOST} when electronic device 301B is not enabled for charging.

Accordingly, when electronic device 301B is not enabled for charging (meaning system voltage V_{SYS} is unavailable), and battery voltage V_{BAT} is not sufficient to power multiplexed-supply amplifiers 318 and/or other components, master charger 308B may boost battery voltage V_{BAT} to a higher boost voltage V_{BOOST} that may be capable of powering multiplexed-supply amplifiers 318 and/or other components. For example, in situations when source voltage V_{SOURCE} is high enough, boost voltage V_{BOOST} may be simply coupled to source voltage V_{SOURCE} via switches. As another example, if source voltage V_{SOURCE} is not high enough, then boost voltage V_{BOOST} may be generated as a step up from either source voltage V_{SOURCE}, battery voltage V_{BAT}, or a combination thereof. When electronic device 301B is enabled for charging, boost voltage V_{BOOST} may be derived from either source voltage V_{SOURCE} and/or as a multiple of battery voltage V_{BAT}.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An electronic device comprising:
a battery; and
a power converter coupled to the battery and configured to be coupled between the battery and a power source, the power converter further configured to:
in a first mode, couple to the power source having a source voltage and charge the battery with a charging voltage significantly smaller than the source voltage; and
in a second mode, couple between at least one downstream component of the electronic device and the battery to provide electrical energy to the at least one downstream component from the battery at a boost voltage significantly larger than a battery voltage generated by the battery.

2. The electronic device of claim 1, wherein the power converter comprises a charge pump power converter.

3. The electronic device of claim 1, wherein the power converter comprises a switched-capacitor power converter.

4. The electronic device of claim 1, wherein the power converter comprises a switched-inductor power converter.

5. The electronic device of claim 1, wherein the power converter comprises a master charger.

6. The electronic device of claim 1, further comprising a master charger coupled to the battery and configured to be coupled between the battery and the power source and configured to provide electrical energy to the at least one downstream component at a system voltage when coupled to the power source during the first mode.

7. The electronic device of claim 6, wherein the at least one downstream component comprises an amplifier.

8. The electronic device of claim 7, wherein the amplifier is configured to drive a transducer.

9. The electronic device of claim 7, wherein the amplifier comprises selection logic for selecting a power supply for the amplifier between the system voltage and the boost voltage.

10. The electronic device of claim 1, wherein the at least one downstream component comprises an amplifier.

11. The electronic device of claim 9, wherein the amplifier is configured to drive a transducer.

12. A method comprising, in a system having a battery and a power converter coupled to the battery and configured to be coupled between the battery and a power source:
in a first mode, coupling the power converter to the power source having a source voltage and charging the battery with a charging voltage significantly smaller than the source voltage; and
in a second mode, coupling the power converter between at least one downstream component of the electronic device and the battery to provide electrical energy to the at least one downstream component from the battery at a boost voltage significantly larger than a battery voltage generated by the battery.

13. The method of claim 12, wherein the power converter comprises a charge pump power converter.

14. The method of claim 12, wherein the power converter comprises a switched-capacitor power converter.

15. The method of claim 12, wherein the power converter comprises a switched-inductor power converter.

12. e method of claim 12, wherein the power converter comprises a master charger.

17. The method of claim 12, further comprising coupling a master charger to the battery and configured to be coupled between the battery and the power source and configured to provide electrical energy to the at least one downstream component at a system voltage when coupled to the power source during the first mode.

18. The method of claim 17, wherein the at least one downstream component comprises an amplifier.

19. The method of claim 18, wherein the amplifier is configured to drive a transducer.

20. The method of claim 18, wherein the amplifier comprises selection logic for selecting a power supply for the amplifier between the system voltage and the boost voltage.

21. The method of claim 12, wherein the at least one downstream component comprises an amplifier.

22. The electronic device of claim 21, wherein the amplifier is configured to drive a transducer.
